(19) United States
(12) Patent Application Publication
(10) Pub. No.: US 2012/0030024 A1
(43) Pub. Date: Feb. 2, 2012

(54) METHOD AND SYSTEM FOR DIRECT OR INDIRECT OFFERS PROCESSING VIA CONSUMER CELL PHONES

(75) Inventor: Anton Bakker, Norfolk, VA (US)

(73) Assignee: OUTSITE NETWORKS, INC., Norfolk, VA (US)

(21) Appl. No.: 13/191,819

(22) Filed: Jul. 27, 2011

Related U.S. Application Data
(60) Provisional application No. 61/364,289, filed on Jul. 28, 2010.

(51) Int. Cl. G06Q 30/00

(52) U.S. Cl. 705/14.65

(57) ABSTRACT

A system, method and computer program product for generating and processing consumer offers or incentives, including a consumer account offers system configured to receive from a consumer client device a consumer account identification number and a point-of-sale (POS) identification number; the consumer account offers system configured to generate and directly provide to a POS system coupled to the consumer account offers system and to a POS terminal, offer information, based on the received consumer account identification number and the POS identification number; and alternatively or in conjunction with the consumer account offers system generating and directly providing to the POS system the offer information, the consumer account offers system configured to provide the offer information to the POS terminal indirectly via a pseudo bar code generator coupled to the POS terminal.

### CROSS REFERENCE TO RELATED APPLICATIONS

The present invention claims benefit of priority to U.S. Provisional Patent Application Ser. No. 61/364,289 of BAKKER, entitled “METHOD AND SYSTEM FOR DIRECT OR INDIRECT OFFERS PROCESSING VIA CONSUMER CELL PHONES,” filed on Jul. 28, 2010, the entire disclosure of which is hereby incorporated by reference herein.

### BACKGROUND OF THE INVENTION

1. Field of the Invention

The present invention generally relates to systems and methods for processing consumer offers or incentives, and more particularly to a system and method for generating and processing consumer offers or incentives via consumer cell phones and point-of-sale (POS) terminals.

2. Discussion of the Background

Systems have been employed for numerous years at point-of-sale (POS) terminals for processing consumer offers or incentives. However, the present systems and methods typically are only configured for processing of consumer offers or incentives directly at the point-of-sale (POS) terminals.

### SUMMARY OF THE INVENTION

Therefore, there is a need for a method and system that addresses the above and other problems with conventional systems and methods for processing consumer offers or incentives. The above and other problems are addressed by the exemplary embodiments of the present invention, which provide a novel system and method for processing of consumer offers or incentives via consumer cell phones and point-of-sale (POS) terminals. For example, a consumer cell phone sends cell phone account and POS terminal ID information to an account offers system that determines corresponding offers or incentives and sends corresponding offers or incentives information directly or indirectly to the POS terminal associated with the ID information for processing. Advantageously, the offers or incentives can be configured as coupons, virtual currency, and the like, and processed by the POS terminal along with any other coupons and purchased products for generating a sales receipt.

Accordingly, in exemplary aspects of the present invention there is provided a system, method and computer program product for generating and processing consumer offers or incentives, including a consumer account offers system configured to receive from a consumer client device a consumer account identification number and a point-of-sale (POS) identification number; the consumer account offers system configured to generate and directly provide to a POS system coupled to the consumer account offers system and to a POS terminal, offer information, based on the received consumer account identification number and the POS identification number; and alternatively or in conjunction with the consumer account offers system generating and directly providing to the POS system the offer information, the consumer account offers system configured to provide the offer information to the POS terminal indirectly via a pseudo bar code generator coupled to the POS terminal.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary pseudo bar code generation system;

FIG. 2 illustrates an exemplary flow chart corresponding to the exemplary pseudo bar code generation system of FIG. 1;

FIG. 3 illustrates an exemplary system for processing of consumer offers or incentives via consumer cell phones and point-of-sale (POS) terminals; and

FIG. 4 illustrates an exemplary flow chart corresponding to the exemplary system of FIG. 3.

### DETAILED DESCRIPTION OF THE PREFERRED EMBODIMENTS

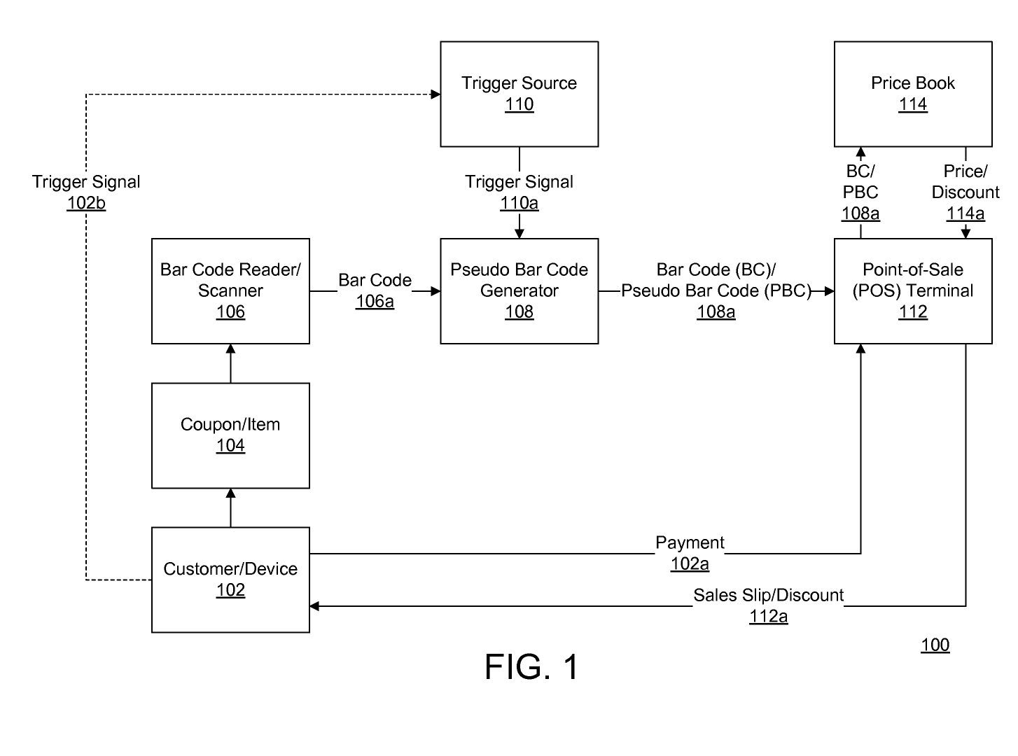

Referring now to the drawings, wherein like reference numerals designate identical or corresponding parts throughout the several views, and more particularly to FIG. 1 thereof, there is illustrated an exemplary pseudo bar code generation system 100. In FIG. 1, the system 100 includes a customer or customer device 102 that presents a coupon or item 104 to a bar code reader or scanner 106. Under normal operation, the bar code reader or scanner 106 reads a bar code (BC) from the coupon or item 104 and sends a corresponding bar code 106a to a pseudo bar code generator 108, which passes the bar code 106a as bar code 108a to a point-of-sale (POS) terminal 112 for generating a sales slip 112a for processing payment 102a from the customer or device 102. The POS terminal 112, based on the received bar code 108a, queries a price book 114 to determine the price or discount 114a corresponding to the item or coupon 104 for generating the sales slip 112a.

If, however, a trigger source 110 generates a trigger signal 110a that is received by the pseudo bar code generator 108, the pseudo bar code generator 108 generates a pseudo bar code (PBC) 108a that also is sent to the POS terminal 112 for processing. The POS terminal 112, based on the received pseudo bar code 108a, queries the price book 114 to determine the action to be performed based on the pseudo bar code 108a. For example, if the pseudo bar code 108a corresponds to a discount, the discount 114a is included along with any other processed items or coupons in the generated sales slip 112a. Similarly, if the if the pseudo bar code 108a corresponds to virtual currency, the amount of such virtual currency is processed as a form of payment, along with any other processed items or coupons in the generated sales slip 112a. For example, if the item 104 presented is soda pop with a price of one dollar ($1.00) and the pseudo bar code 108a corresponds to a virtual 50 cents ($0.50), such information would be reflected in the price book 114, and the resulting sales slip 112a would be for 50 cents ($1.00-$0.50). In a similar manner, the pseudo bar code 108a can be configured as virtual coupons, incentives, and the like.

In further exemplary embodiments, the trigger signal 110a can be generated based on the customer or device 102 or a signal 102b therefrom, for example, based on loyalty or smart cards, biometric information, such as speech, facial, retina, thumbprint, etc., recognition, and the like. Advantageously, the exemplary system 100, due to the pseudo bar code generator 108 interposed between the bar code reader or scanner 106 and the POS terminal 112, requires minimal or minor changes to existing POS systems, as the pseudo bar code generator 108 passes the received bar codes from the bar code reader or scanner 106 in the absence of the trigger signal 110a.

In further exemplary embodiments, the trigger source 110 can be part of a client server system, wherein a client (the device 102) interfaces with a server (the trigger source 110) to determine the corresponding trigger signal 110a for causing the pseudo bar code generator 108 to generate a corresponding pseudo bar code 108a, for example, based on shopping history, demographics, and the like, of the customer or device 102.

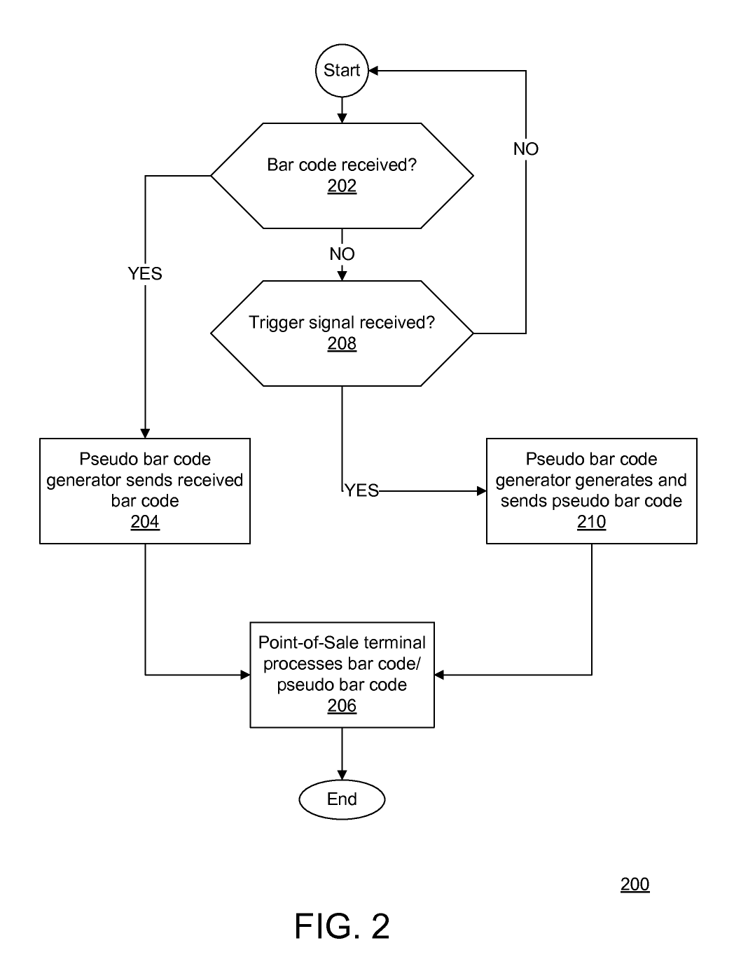

FIG. 2 illustrates an exemplary flow chart 200 corresponding to the exemplary pseudo bar code generation system of FIG. 1. In FIG. 2, at step 202, the pseudo bar code generator 108 determines if a bar code has been received from the bar code reader or scanner 106 and if so at step 204 sends the received bar code to the POS terminal 112 for processing at step 206. If a bar code has not been received from the bar code reader or scanner 106, as determined by step 202, and a trigger signal has not been received from the trigger source 110, as determined by step 208, then the processing is restarted for further downstream processing of bar codes and/or trigger signals. If, however, step 208 determines that a trigger signal has been received from the trigger source 110, the pseudo bar code generator 108 at step 210 generates a corresponding pseudo bar code and sends the generated pseudo bar code to the POS terminal 112 for processing at step 206. In this way, the bar codes and the pseudo bar codes can be processed by the POS terminal 112 for generating a corresponding sales slip.

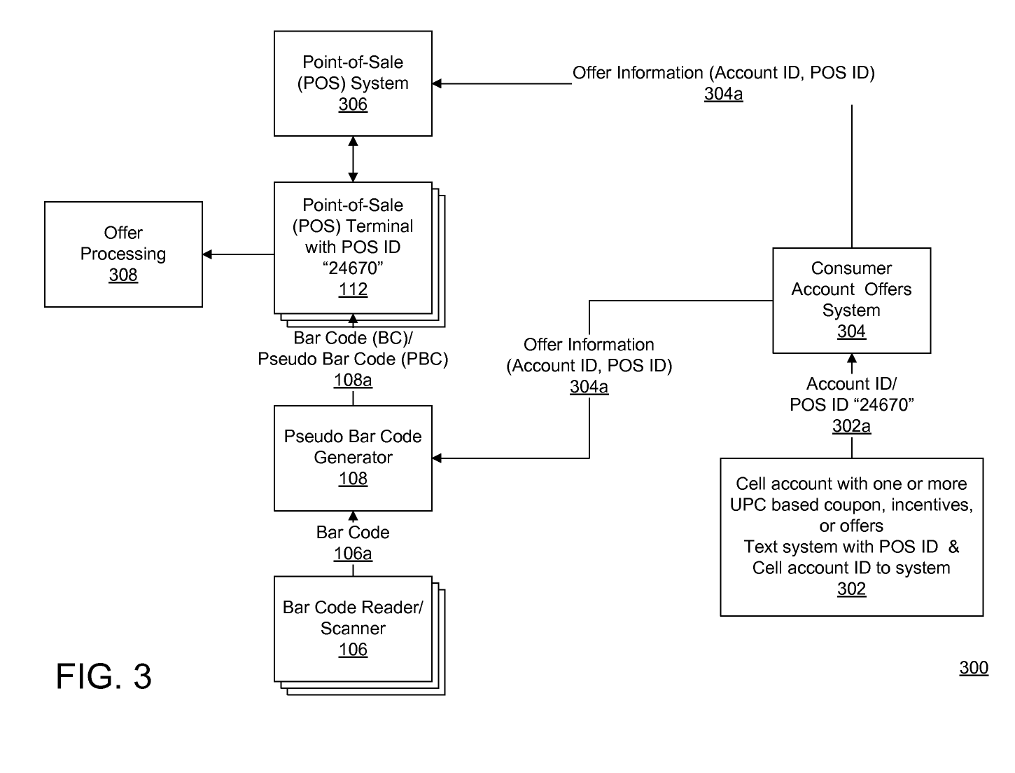

FIG. 3 illustrates an exemplary system 300 for processing of consumer offers or incentives via consumer cell phones and point-of-sale (POS) terminals. The system 300 can include one or more of the components from the systems and method described with respect to FIGS. 1-2, wherein the common components, will not be described in detail for the sake of brevity.

In FIG. 3, the system 300 can include a consumer device 302 (e.g., cell phone, PDA, handheld device, etc.) coupled to a consumer account offers system 304 (e.g., computer server based), which is coupled to the point-of-sale terminal 112, directly through a point-of-sale system 306 (e.g., computer server based) or indirectly through the pseudo barcode generator 108. The consumer device 302 transmits cell phone account identification (ID) and point-of-sale terminal 112 ID information 302a (e.g., via Short Message Service (SMS), Multimedia Messaging Service (MMS), text message, instant messaging (IM), e-mail, web interface, Bluetooth, etc.) to the consumer account offers system 304. Based on the information 302a, the consumer account offers system 304 generates offer information 304a. The offer information 304a can be transmitted directly to the point-of-sale terminal 112 via the point-of-sale system 306 or can be transmitted indirectly to the point-of-sale terminal 112 via the pseudo barcode generator 108. Based on the received offer information 304a, the point-of-sale terminal 112 performs offer processing 308. In further exemplary embodiments, the consumer device 302 can transmit any suitable location information, point-of-sale terminal information, and the like (e.g., via Short Message Service (SMS), Multimedia Messaging Service (MMS), text message, instant messaging (IM), e-mail, web interface, Bluetooth, etc.), to perform the offer processing, as will be appreciated by those of ordinary skill in the relevant art(s).

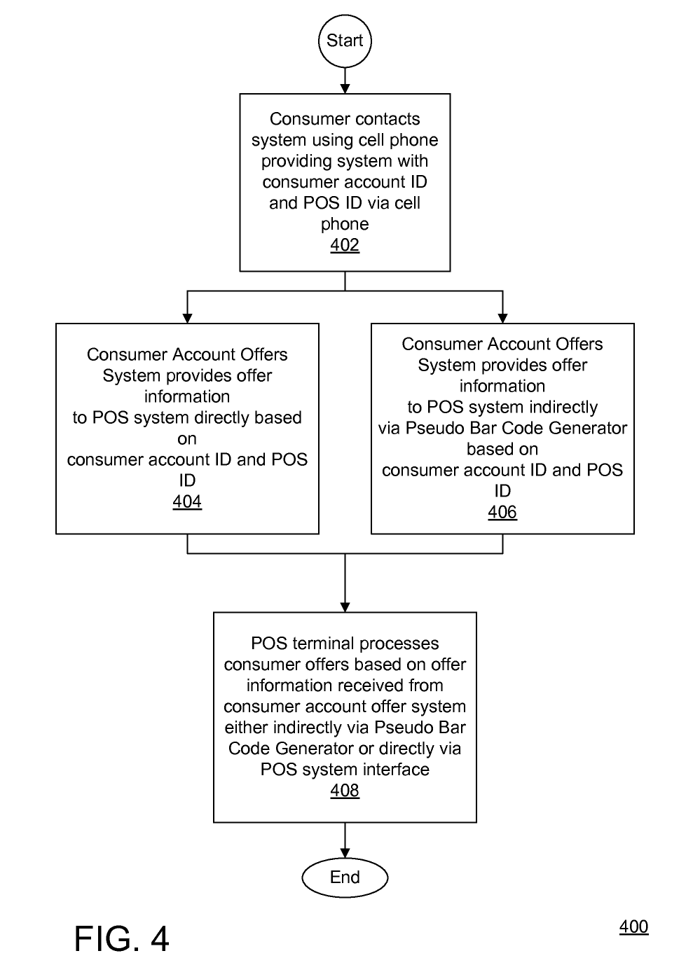

FIG. 4 illustrates an exemplary flow chart corresponding to the exemplary system of FIG. 3. In FIG. 4, at step 402, a consumer contacts the consumer account offers system 304 using the consumer device 302 to provide the consumer account offers system 304 with a consumer account ID and the POS 112 ID (e.g., POS ID “24670”) via the consumer device 302. At step 404, the consumer account offers system 304 generates and provides the offer information 304a, based on the consumer account ID and the POS ID, to the POS terminal 112 directly via the POS system 306. Alternatively or in conjunction, at step 406, the consumer account offers system 304 provides the offer information 304a, based on the consumer account ID and the POS ID, to the POS terminal 112 indirectly via the pseudo bar code generator 108. Control then proceeds to step 408, where POS terminal 112 processes the consumer offers based on offer information 304a received from the consumer account offer system 304 either indirectly via the pseudo bar code generator 108 or directly via the POS system 306 interface, completing the process.

The above-described devices and subsystems of the exemplary embodiments of FIGS. 1-4 can include, for example, any suitable servers, workstations, PCs, laptop computers, PDAs, Internet appliances, handheld devices, cellular telephones, wireless devices, other devices, and the like, capable of performing the processes of the exemplary embodiments of FIGS. 1-4. The devices and subsystems of the exemplary embodiments of FIGS. 1-4 can communicate with each other using any suitable protocol and can be implemented using one or more programmed computer systems or devices.

One or more interface mechanisms can be used with the exemplary embodiments of FIGS. 1-4, including, for example, Internet access, telecommunications in any suitable form (e.g., voice, modem, and the like), wireless communications media, and the like. For example, the employed communications networks can include one or more wireless communications networks, cellular communications networks, 3G communications networks, Public Switched Telephone Network (PSTNs), Packet Data Networks (PDNs), the Internet, intranets, a combination thereof, and the like. Accordingly, the devices and subsystems of the exemplary embodiments can be implemented on the World Wide Web.

It is to be understood that the devices and subsystems of the exemplary embodiments of FIGS. 1-4 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 1-4 can be implemented via one or more programmed computer systems or devices.

To implement such variations as well as other variations, a single computer system can be programmed to perform the special purpose functions of one or more of the devices and subsystems of the exemplary embodiments of FIGS. 1-4. On the other hand, two or more programmed computer systems or devices can be substituted for any one of the devices and subsystems of the exemplary embodiments of FIGS. 1-4. Accordingly, principles and advantages of distributed processing, such as redundancy, replication, and the like, also can be implemented, as desired, to increase the robustness and performance the devices and subsystems of the exemplary embodiments of FIGS. 1-4.

The devices and subsystems of the exemplary embodiments of FIGS. 1-4 can store information relating to various processes described herein. This information can be stored in one or more memories, such as a hard disk, optical disk, magneto-optical disk, RAM, and the like, of the devices and subsystems of the exemplary embodiments of FIGS. 1-4. One or more databases of the devices and subsystems of the exemplary embodiments of FIGS. 1-4 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-4 can include appropriate data structures for storing data collected and/or generated by the processes of the devices and subsystems of the exemplary embodiments of FIGS. 1-4 in one or more databases thereof.

All or a portion of the devices and subsystems of the exemplary embodiments of FIGS. 1-4 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 1-4 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1-4, for driving the devices and subsystems of the exemplary embodiments of FIGS. 1-4, for enabling the devices and subsystems of the exemplary embodiments of FIGS. 1-4 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 1-4. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1-4 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

Advantageously, the systems and methods described with respect to FIGS. 1-4 can be used alone or in combination, as will be appreciated by those of ordinary skill in the relevant art(s).

While the present invention have been described in connection with a number of exemplary embodiments and implementations, the present invention is not so limited, but rather covers various modifications and equivalent arrangements, which fall within the purview of the appended claims.

What is claimed is:

1. A system for generating and processing consumer offers or incentives, the system comprising:
a consumer account offers system configured to receive from a consumer client device a consumer account identification number and a point-of-sale (POS) identification number;
the consumer account offers system configured to generate and directly provide to a POS system coupled to the consumer account offers system and to a POS terminal, offer information, based on the received consumer account identification number and the POS identification number; and
alternatively or in conjunction with the consumer account offers system generating and directly providing to the POS system the offer information, the consumer account offers system configured to provide the offer information to the POS terminal indirectly via a pseudo bar code generator coupled to the POS terminal.

2. The system of claim 2, wherein the POS terminal is configured to process one or more consumer offers based on the offer information received from the consumer account offer system either indirectly via the pseudo bar code generator or directly via the POS system.

3. A computer implemented method for generating and processing consumer offers or incentives, the method comprising:
receiving by a consumer account offers system from a consumer client device a consumer account identification number and a point-of-sale (POS) identification number;
generating and directly providing by the consumer account offers system to a POS system coupled to the consumer account offers system and to a POS terminal, offer information, based on the received consumer account identification number and the POS identification number; and
alternatively or in conjunction with the consumer account offers system generating and directly providing to the POS system the offer information, providing by the consumer account offers system the offer information to the POS terminal indirectly via a pseudo bar code generator coupled to the POS terminal.

4. The method of claim 3, further comprising processing by the POS terminal one or more consumer offers based on the offer information received from the consumer account offer system either indirectly via the pseudo bar code generator or directly via the POS system.

5. A computer program product for generating and processing consumer offers or incentives and including one or more computer readable instructions embedded on a computer readable medium and configured to cause one or more computer processors to perform the steps of:
receiving by a consumer account offers system from a consumer client device a consumer account identification number and a point-of-sale (POS) identification number;
generating and directly providing by the consumer account offers system to a POS system coupled to the consumer account offers system and to a POS terminal, offer information, based on the received consumer account identification number and the POS identification number; and
alternatively or in conjunction with the consumer account offers system generating and directly providing to the POS system the offer information, providing by the consumer account offers system the offer information to the POS terminal indirectly via a pseudo bar code generator coupled to the POS terminal.

6. The computer program product of claim 5, further comprising processing by the POS terminal one or more consumer offers based on the offer information received from the consumer account offer system either indirectly via the pseudo bar code generator or directly via the POS system.
